(19) United States
(12) Patent Application Publication
(10) Pub. No.: US 2026/0003794 A1
(43) Pub. Date: Jan. 1, 2026

(54) Balanced Latency Stacked Cache

(71) Applicant: Advanced Micro Devices, Inc., Santa Clara, CA (US)

(72) Inventor: Carl Dean Dietz, Columbia City, IN (US)

(73) Assignee: Advanced Micro Devices, Inc., Santa Clara, CA (US)

(21) Appl. No.: 18/758,517

(22) Filed: Jun. 28, 2024

(51) Int. Cl. G06F 12/0895; G06F 12/0897; G06F 13/16

(52) U.S. Cl. CPC G06F 12/0895; G06F 12/0897; G06F 13/161

(57) ABSTRACT

In accordance with described techniques for balanced latency stacked cache, a stacked cache system includes a first cache die and at least a second cache die in a stacked orientation with the first cache die. The stacked cache system includes cache control circuitry that is centrally located in the stacked cache system. The stacked cache system also includes connection vias configured vertically in a center of the stacked cache system as interconnected inputs and outputs of the first cache die and the second cache die.

### BACKGROUND

Integrated circuits and/or chips are fabricated on semiconductor material, such as silicon, and include individual semiconductor components, referred to as dies. In one or more variations, a die includes one or more execution units, control units, registers, cache memories, and/or other functional units that enable execution of instructions. Further, the die includes one or more physical communication channels, or interconnects, that facilitate communication between different components of the die. On-chip networks are used to facilitate the transfer of data via the physical communication channels to the different components of the die. An on-chip network includes communication infrastructure integrated onto the die, such as one or more buses, point-to-point connections, or more complex mesh architectures. On-chip networks are also referred to as a network-on-chip (NoC), an interconnect fabric, a data fabric, or a routing fabric.

### BRIEF DESCRIPTION OF THE DRAWINGS

The detailed description is described with reference to the accompanying figures.

FIG. 1 depicts a non-limiting example of a stacked cache system, as related to balanced latency stacked cache as described herein.

FIG. 2 depicts another non-limiting example of a stacked cache system with additional cache die, such as related to aspects of balanced latency stacked cache as described herein.

FIG. 3 depicts another non-limiting example of a stacked cache system, such as related to aspects of balanced latency stacked cache as described herein.

FIG. 4 depicts another non-limiting example of a stacked cache system with separate L2 and L3 cache die, such as related to aspects of balanced latency stacked cache as described herein.

FIG. 5 depicts another non-limiting example of a stacked cache system with combined L2 and L3 cache die, such as related to aspects of balanced latency stacked cache as described herein.

FIG. 6 depicts another non-limiting example of a stacked cache system with separate L2 and L3 cache die in a side stack configuration, such as related to aspects of balanced latency stacked cache as described herein.

FIG. 7 depicts a procedure in example implementations of balanced latency stacked cache, as described herein.

### DETAILED DESCRIPTION

In aspects of the techniques described herein for balanced latency stacked cache, a stacked cache system includes a first cache die, and at least a second cache die in a stacked orientation with the first cache die. In implementations, the first cache die and the second cache die are stacked data arrays, and the stacked cache system is a layer2 (L2) stacked cache with a vertical orientation of the second cache die located over the first cache die. In other implementations, the stacked cache system is static random access memory (SRAM) in a vertical stacked orientation, or is dynamic random access memory (DRAM) in the vertical stacked orientation. Additionally, the stacked cache system includes a base die, in which case the first cache die is integrated with the base die, and the second cache die is in the stacked orientation over the first cache die.

The stacked cache system also includes cache control circuitry that is centrally located in the stacked cache system. In some implementations, the cache control circuitry and a tag field are integrated with the base die, separate from the first cache die and the second cache die of the stacked cache system. The stacked cache system also includes connection vias, such as through silicon vias (TSVs) or bond pad vias (BPVs) configured vertically in a center of the stacked cache system, and the connection vias are the interconnected inputs and outputs of the first cache die and the second cache die.

In aspects of the described techniques, the configuration of the stacked cache system reduces response latency when accessing the stacked cache, and also provides a power savings feature. The stacked cache system improves data transfer performance, and has a lower latency than a conventional planar cache built on a single die. Notably, the connection vias are routed into and out of the center of the stacked cache system. This avoids adding wire stages (also referred to herein as pipe stages), as in a conventional planar cache, to route data over one part of the cache to reach a portion of the cache that is further away from the data I/Os. In the described techniques, the connection vias that are routed center of the stacked cache system create balanced (or identical) latencies between the two halves of the stacked cache system on the stacked die (e.g., of the first cache die and the at least second cache die). For example, a conventional planar 1 MB L2M cache has a 14 cycle latency, while a stacked 1 MB L2M cache implemented using the described techniques has only a 12 cycle latency. This provides for implementation of a larger stacked cache than a typical planar cache, yet achieves the same or better cycle latency.

The conventional configurations of a 1 MB L2 cache and a 2 MB L2 cache are generally illustrative of examples using pipeline staging to obtain the data array addressing for performing data I/O on the cache. In a 1 MB L2 cache, an incoming access request routes through the cache control circuitry and interface, through a first tag field on a first side of the cache, into the pipeline flops, and over to the second tag field on the second side of the cache. The cycles reverse for the data access return, requiring an extra cycle for both incoming data and return data. It takes an additional full cycle for the incoming access request to reach the second side of the cache, and then another full cycle for the second tag field to distribute not just horizontally, but also vertically. The problem is compounded as the size of the cache is increased in a planar configuration, such as for the 2 MB L2 cache, where additional pipeline stages are added to the planar cache to handle the increased distance that an incoming access request needs to be routed, and reversed for the data access return.

In other aspects of the described techniques, the configuration of the stacked cache system, with the cache control circuitry and the tag field integrated with the base die and separate from the cache dies, provides that the cache control circuitry performs a tag lookup prior to a vertical access request into the stacked data arrays via the connection vias. The vertical connection vias implemented in the center of the stacked cache provide that an incoming access request to the cache control circuitry is routed either left or right, using only one cycle rather than multiple cycles to route through the cache array. The fewer pipeline stages to obtain data array addressing for performing data I/O on the cache results in a decreased or lower latency, and the data is accessed and returned faster for better performance.

Accordingly, the described aspects of balanced latency stacked cache provides lower latency for an access request, and data is returned from the data cache faster. There is also a power savings due to an access request being accomplished in fewer cycles, so an L2 cache for example, is not turned on for as long, as well as a power savings when transitioning sooner from an active state to an idle state of the cache. Additionally, wire lengths in the cache die are shorter, which effectively results in less capacitance and also conserves power. There is also less signal loading because the signals are only traveling half the distance for an access request, and the data return. Further, less heat is being generated as a result of the power savings, less capacitance, and signals traveling less distance.

In some aspects, the techniques described herein relate to a stacked cache system including a first cache die, a second cache die in a stacked orientation with the first cache die, cache control circuitry centrally located in the stacked cache system, and connection vias configured vertically in a center of the stacked cache system as interconnected inputs and outputs of the first cache die and the second cache die.

In some aspects, the techniques described herein relate to a stacked cache system, where the cache control circuitry vertically bifurcates between the first cache die and the second cache die.

In some aspects, the techniques described herein relate to a stacked cache system, where the cache control circuitry centrally located in the stacked cache system horizontally bifurcates a first section and a second section of the first cache die, and horizontally bifurcates a first section and a second section of the second cache die.

In some aspects, the techniques described herein relate to a stacked cache system, where the stacked cache system is a layer2 (L2) stacked cache with a vertical orientation of the second cache die located over the first cache die.

In some aspects, the techniques described herein relate to a stacked cache system, where the first cache die comprises a first L2 stacked cache and the second cache die comprises a second L2 stacked cache, and the first L2 stacked cache is configured in a stacked orientation with at least the second L2 stacked cache in the stacked cache system.

In some aspects, the techniques described herein relate to a stacked cache system, where the stacked cache system is one of static random access memory (SRAM) in a vertical stacked orientation or dynamic random access memory (DRAM) in the vertical stacked orientation.

In some aspects, the techniques described herein relate to a stacked cache system, further including a base die, and wherein the first cache die is integrated with the base die, and the second cache die is in the stacked orientation over the first cache die.

In some aspects, the techniques described herein relate to a stacked cache system, where the cache control circuitry and a tag field are integrated with the base die, separate from the first cache die and the second cache die.

In some aspects, the techniques described herein relate to a stacked cache system, where the cache control circuitry and a tag field are integrated with the base die, and the first cache die and the second cache die are stacked data arrays.

In some aspects, the techniques described herein relate to a stacked cache system, where the cache control circuitry is configured to perform a tag lookup prior to a vertical access request into the stacked data arrays via the connection vias that are configured vertically in the center of the stacked cache system.

In some aspects, the techniques described herein relate to a method including accessing data in a stacked cache system by connection vias configured vertically in a center of the stacked cache system that comprises a first cache die and a second cache die in a stacked orientation with the first cache die, and controlling data inputs and data outputs with cache control circuitry centrally located in the stacked cache system.

In some aspects, the techniques described herein relate to a method, where the cache control circuitry vertically bifurcates between the first cache die and the second cache die.

In some aspects, the techniques described herein relate to a method, where the stacked cache system is a L2 stacked cache with a vertical orientation of the second cache die located over the first cache die.

In some aspects, the techniques described herein relate to a method, where the stacked cache system is one of SRAM in a vertical stacked orientation or DRAM in the vertical stacked orientation.

In some aspects, the techniques described herein relate to a method, where the first cache die is integrated with a base die of the stacked cache system, and the second cache die is in the stacked orientation over the first cache die.

In some aspects, the techniques described herein relate to a method, where the cache control circuitry and a tag field are integrated with a base die of the stacked cache system, separate from the first cache die and the second cache die.

In some aspects, the techniques described herein relate to a method, where the cache control circuitry and a tag field are integrated with a base die of the stacked cache system, and the first cache die and the second cache die are stacked data arrays.

In some aspects, the techniques described herein relate to a method, further including performing a tag lookup prior to a vertical access request into the stacked data arrays via the connection vias that are configured vertically in the center of the stacked cache system.

In some aspects, the techniques described herein relate to a stacked cache system, including a first cache die integrated with a base die, a second cache die in a stacked orientation with the first cache die, and cache control circuitry centrally located in the stacked cache system, the cache control circuitry configured to control data inputs and data outputs via connection vias configured vertically in a center of the stacked cache system.

In some aspects, the techniques described herein relate to a stacked cache system, where the cache control circuitry and a tag field are integrated with the base die, separate from the first cache die and the second cache die.

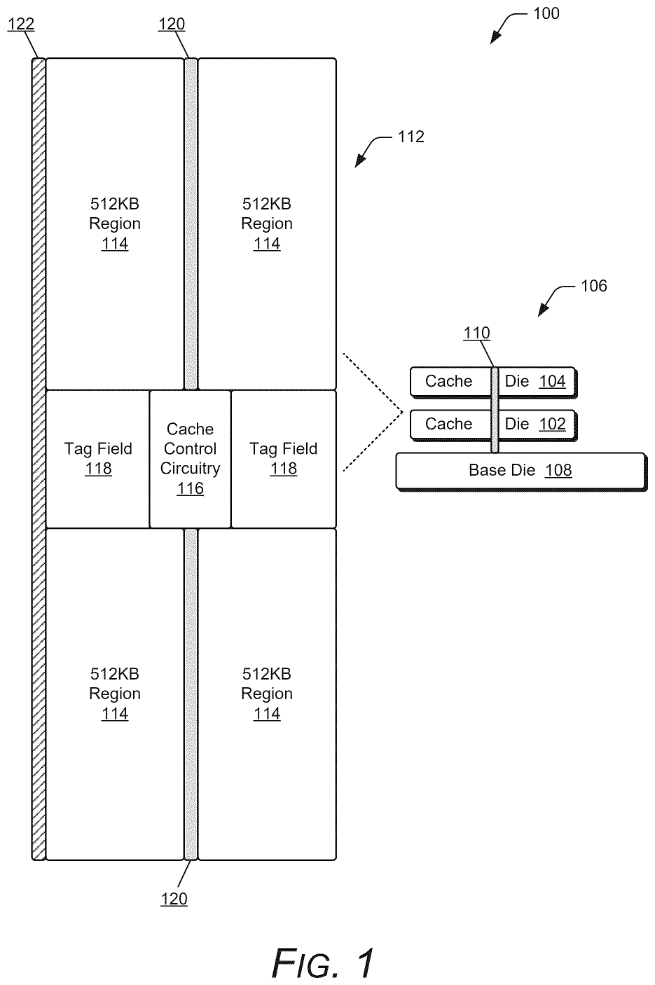

FIG. 1 depicts a non-limiting example of a stacked cache system 100, as related to balanced latency stacked cache as described herein. This example is illustrative of any type of a stacked cache system that includes a first cache die 102 and at least a second cache die 104, as shown in the side view perspective 106. This stacked cache system 100 also includes a base die 108, and connection vias 110 configured vertically in a center of the stacked cache system. In one or more implementations, the connection vias are through silicon vias (TSVs) or bond pad vias (BPVs). In this example, the connection vias 110 are approximately centered up through the first cache die 102 connecting the second cache die 104. The connection vias 110 are the interconnected inputs and outputs of the first cache die and the second cache die. The connection vias are implemented as TSVs if both the first cache die 102 and the second cache die 104 are stacked face up. Alternatively, the connection vias are implemented as BPVs if the first cache die 102 (e.g., the bottom die) is stacked face up and the second cache die 104 (e.g., the top die) is stacked face down. The connection vias 110 that are routed center of the stacked cache system 100 create balanced (or identical) latencies between the two halves of the stacked cache system on a stacked die (e.g., of the first cache die 102 and the at least second cache die 104).

A top view perspective 112 of the stacked cache system 100 illustrates the cache regions 114 of the cache die (102, 104), as well as cache control circuitry 116 and tag fields 118 on either side of the cache control circuitry. The cache control circuitry 116 is also referred to herein as the cache control logic, which also includes an interface to the core, and includes logic circuitry to interface and manage memory access requests, such as received from a processor. Examples of memory access requests include read requests, write requests, fetch requests, pre-fetch requests, and the like. The cache control circuitry 116 manages the access to the data stored in the cache regions 114 of the stacked cache system 100. The tag fields 118 also implement state information and/or a least recently used (LRU) algorithm for the cache memory management. The tag fields 118 also hold the physical address bits, the payload used to determine a specific region of a cache for accessibility, as well as error correction code (ECC) bits and state bits. This example also includes sections 120 of the pipeline flops and drivers connecting the cache control circuitry 116 to the respective the cache regions 114 of the cache die (102, 104). The stacked cache system 100 also includes a data interface 122 to the core.

In implementations, the cache control circuitry 116 is centrally located in the stacked cache system 100, and the cache control circuitry and tag fields 118 are integrated with the base die 108, separate from the first cache die 102 and the second cache die 104. As illustrated the cache control circuitry 116 vertically bifurcates between the first cache die 102 and the second cache die 104. Further, the cache control circuitry 116 that is centrally located in the stacked cache system 100 horizontally bifurcates first and second sections of the first cache die 102, and horizontally bifurcates first and second sections of the second cache die 104.

In implementations, the first cache die 102 and the second cache die 104 are stacked data arrays, and the stacked cache system is a L2 stacked cache with the vertical orientation of the second cache die 104 located over the first cache die 102, as shown in the side view perspective 106. In other implementations, the stacked cache system 100 is static random access memory (SRAM) in the vertical stacked orientation, or is dynamic random access memory (DRAM) in the vertical stacked orientation. In additional implementations, the first cache die 102 is integrated with the base die 108.

In one or more implementations, the techniques described herein for balanced latency stacked cache are used with any cache or memory structure, and is not limited to caches nor is it limited to any specific type of memory. The described techniques are used with any cache or memory organization. The base die 108 and the stacked die (102, 104) have the same or different amounts of memory, as well as the base die 108 and the stacked die (102, 104) have the same or different organization. Further, the base die 108 does not contain the given cache or memory, with only the stacked die (102, 104) having the given cache or memory. In implementations, the vertical connection vias 110 allows expanding the cache die in the stacked configuration. For example, butterflying the L2 organization on the stacked die minimizes latency, which allows for increasing the L2 size without latency penalty.

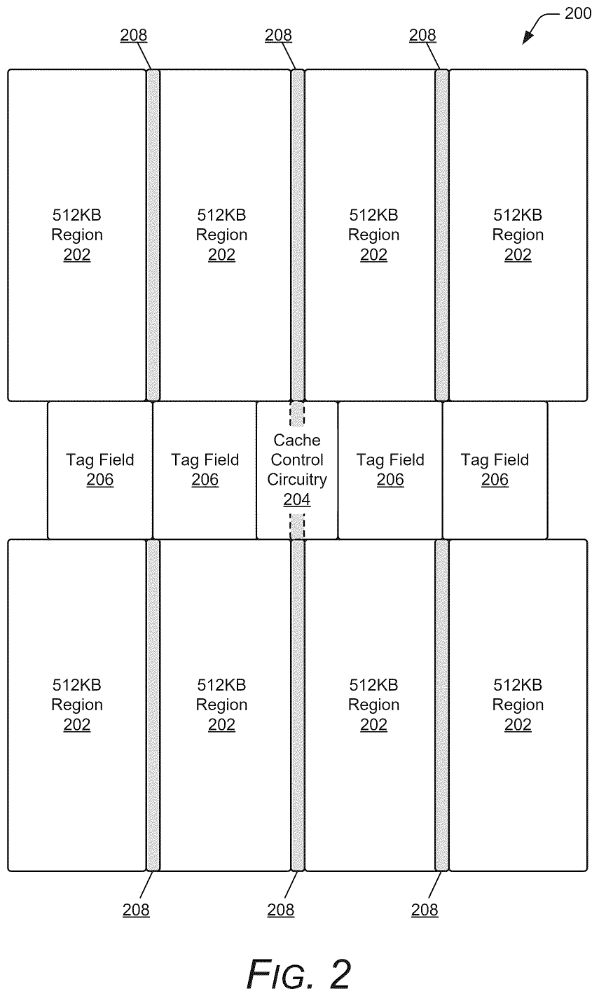

FIG. 2 depicts another non-limiting example of a stacked cache system 200 with additional cache die, such as related to aspects of balanced latency stacked cache, as described herein. This stacked cache system 200 is an example configured with a 2 MB L2 cache portion on a stacked die, and connection vias are used to connect the die vertically (as compared to a 1 MB L2 cache in an example shown in FIG. 1).

The top view perspective of the stacked cache system 200 illustrates the cache regions 202 (e.g., 512 KB regions) of the stacked cache die, as well as a cache control circuitry 204 and tag fields 206 on either side of the cache control circuitry. The cache control 204 is also referred to herein as the cache control logic, which also includes an interface to the core. The tag fields 206 also implement state information and/or a least recently used (LRU) algorithm for the cache memory management. This example also includes sections 208 of the pipeline flops and drivers connecting the cache control circuitry 204 to the respective the cache regions 202 of the stacked cache die. In implementations, the cache control circuitry 204 is centrally located in the stacked cache system 200, and as illustrated, the cache control circuitry 204 vertically and horizontally bifurcates between the stacked cache die.

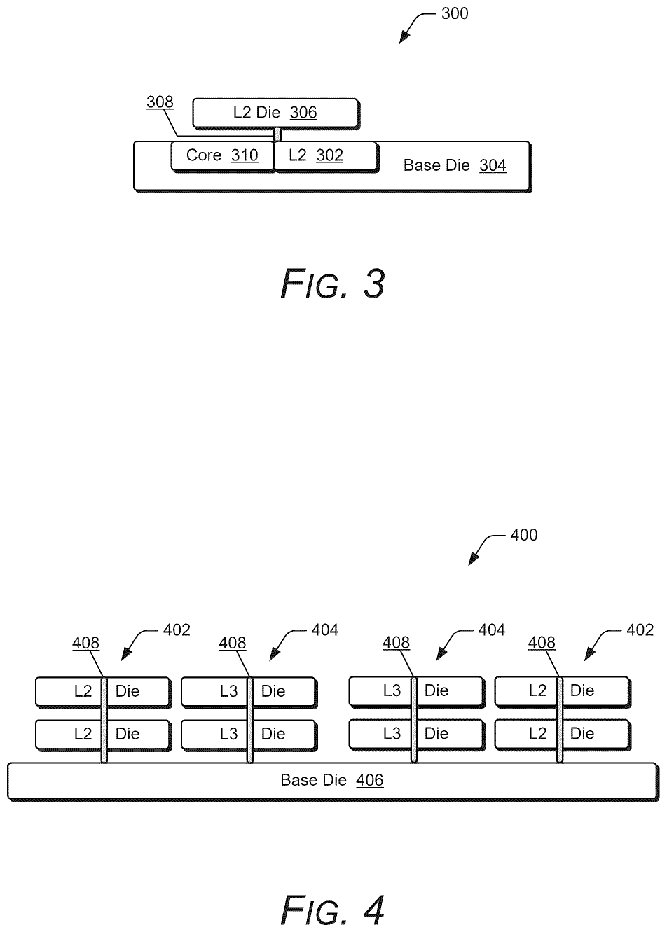

FIG. 3 depicts another non-limiting example of a stacked cache system 300, such as related to aspects of balanced latency stacked cache as described herein. In this example stacked cache system 300, a 1 MB L2 cache 302 is integrated with a base die 304, and the stacked cache system 300 is expanded by adding a 2 MB L2 cache 306 on the stacked die. Connection vias are used to connect the die vertically. This example of the stacked cache system 300 also includes connection vias 308 configured vertically in the stacked cache system, connecting the 1 MB L2 cache 302 to the 2 MB L2 cache 306 on the stacked die and/or connecting the core 310 that is integrated with the base die 304.

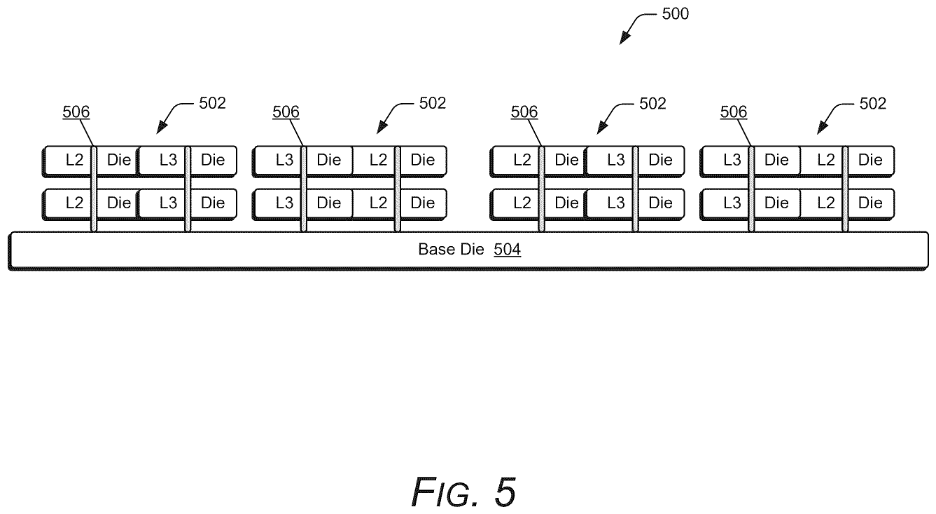

FIG. 4 depicts another non-limiting example of a stacked cache system 400 with separate L2 and L3 cache die, such as related to aspects of balanced latency stacked cache as described herein. In this example stacked cache system 400, L2 dies 402 and L3 dies 404 are stacked separately on a base die 406. This example of the stacked cache system 400 also includes connection vias 408 configured vertically in the stacked cache system, connecting the L2 dies 402 and the L3 dies 404 with the base die 406. The stacked data arrays are butterflied on the memory die, which provides minimizing latency for data transfers.

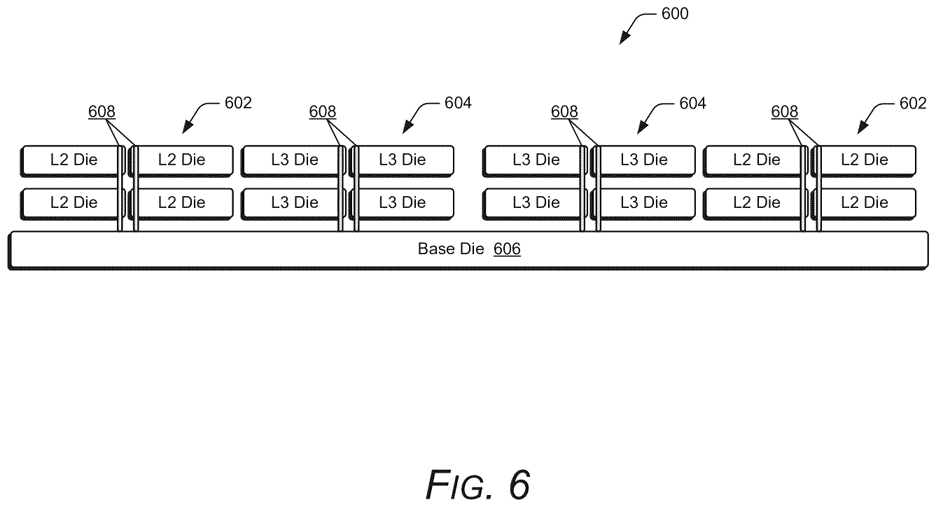

FIG. 5 depicts another non-limiting example of a stacked cache system 500 with combined L2 and L3 cache die, such as related to aspects of balanced latency stacked cache as described herein. In this example stacked cache system 500, combined L2 and L3 dies 502 are stacked on a base die 504. This example of the stacked cache system 500 also includes connection vias 506 configured vertically in the stacked cache system, connecting the combined L2 and L3 dies 502 with the base die 504. The stacked data arrays are butterflied on the memory die, which provides minimizing latency for data transfers.

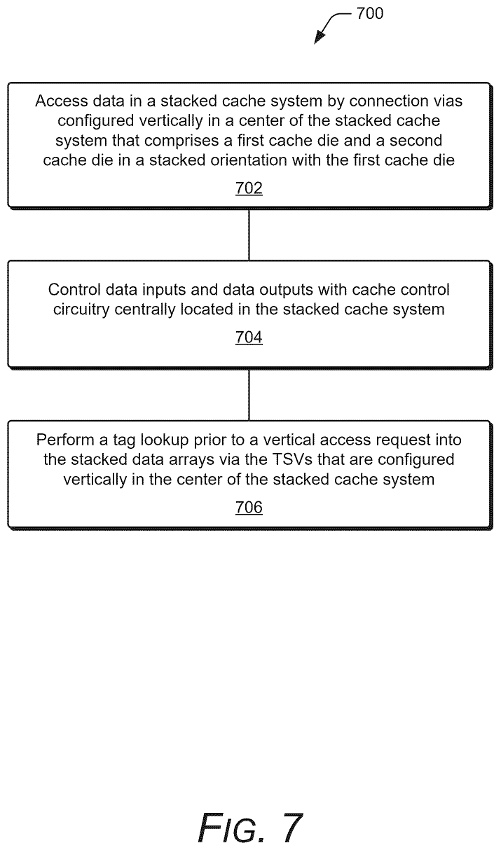

FIG. 6 depicts another non-limiting example of a stacked cache system 600 with separate L2 and L3 cache die in a side stack configuration, such as related to aspects of balanced latency stacked cache as described herein. In this example stacked cache system 600, the side stacked L2 dies 602 and side stacked L3 dies 604 are stacked separately on a base die 606. This example of the stacked cache system 600 also includes connection vias 608 configured vertically in the stacked cache system, connecting the side stacked L2 dies 602 and the side stacked L3 dies 604 with the base die 606. The stacked data arrays are butterflied based on stacked die placement on the memory die, which provides the same (or better) latency benefits as having the butterflied arrays on the memory die.

FIG. 7 is a flow diagram depicting a procedure 700 in an example implementation of balanced latency stacked cache, as described herein. The order in which the procedure is described is not intended to be construed as a limitation, and any number or combination of the described operations are performed in any order to perform the procedure, or an alternate procedure.

In the procedure 700, data in a stacked cache system is accessed by connection vias configured vertically in a center of the stacked cache system that includes a first cache die and a second cache die in a stacked orientation with the first cache die (at 702). For example, the stacked cache system 100 includes the first cache die 102 and at least the second cache die 104. The stacked cache system 100 also includes the base die 108, and the connection vias 110 are approximately centered up through the first cache die 102 connecting the second cache die 104. The connection vias 110 are the interconnected inputs and outputs of the first cache die 102 and the second cache die 104, and the cache control circuitry 116 access data in the stacked cache system 100 via the connection vias 110. In one or more implementations, the connection vias 110 are TSVs or BPVs. The connection vias are implemented as TSVs if both the first cache die 102 and the second cache die 104 are stacked face up. Alternatively, the connection vias are implemented as BPVs if the first cache die 102 (e.g., the bottom die) is stacked face up and the second cache die 104 (e.g., the top die) is stacked face down.

Data inputs and data outputs are controlled with a cache control circuitry centrally located in the stacked cache system (at 704). For example, the cache control circuitry 116 that is centrally located in the stacked cache system 100 controls the data inputs and data outputs via the connection vias 110. In implementations, the cache control circuitry 116 and the tag fields 118 are integrated with the base die 108, separate from the first cache die 102 and the second cache die 104. Further, the cache control circuitry 116 vertically bifurcates between the first cache die 102 and the second cache die 104, where the cache control circuitry 116 horizontally bifurcates first and second sections of the first cache die 102, and horizontally bifurcates first and second sections of the second cache die 104.

A tag lookup is performed prior to a vertical access request into the stacked data arrays via the connection vias that are configured vertically in the center of the stacked cache system (at 706). For example, the cache control circuitry 116 and the tag fields 118 are integrated with the base die 108 of the stacked cache system 100, where the first cache die 102 and the second cache die 104 are stacked data arrays. The cache control circuitry 116 performs a tag lookup prior to a vertical access request into the stacked data arrays via the connection vias 110.

The various functional units illustrated in the figures and/or described herein (including, where appropriate, the stacked cache system 100, the first cache die 102, the second cache die 104, the base die 108, and the connection vias 110) are implemented in any of a variety of different forms, such as in hardware circuitry, software, and/or firmware executing on a programmable processor, or any combination thereof. The procedures provided are implementable in any of a variety of devices, such as a general-purpose computer, a processor, a processor core, and/or an in-memory processor. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Although implementations of balanced latency stacked cache have been described in language specific to features, elements, and/or procedures, the appended claims are not necessarily limited to the specific features, elements, or procedures described. Rather, the specific features, elements, and/or procedures are disclosed as example implementations of balanced latency stacked cache, and other equivalent features, elements, and procedures are intended to be within the scope of the appended claims. Further, various different examples are described herein and it is to be appreciated that many variations are possible and each described example is implementable independently or in connection with one or more other described examples.

What is claimed is:

1. A stacked cache system, comprising:
a first cache die;
a second cache die in a stacked orientation with the first cache die;
cache control circuitry centrally located in the stacked cache system; and
connection vias configured vertically in a center of the stacked cache system as interconnected inputs and outputs of the first cache die and the second cache die.

2. The stacked cache system of claim 1, wherein the cache control circuitry vertically bifurcates between the first cache die and the second cache die.

3. The stacked cache system of claim 1, wherein the cache control circuitry centrally located in the stacked cache system horizontally bifurcates a first section and a second section of the first cache die, and horizontally bifurcates a first section and a second section of the second cache die.

4. The stacked cache system of claim 1, wherein the stacked cache system is a layer2 (L2) stacked cache with a vertical orientation of the second cache die located over the first cache die.

5. The stacked cache system of claim 1, wherein the first cache die comprises a first layer2 (L2) stacked cache and the second cache die comprises a second L2 stacked cache, and wherein the first L2 stacked cache is configured in a stacked orientation with at least the second L2 stacked cache in the stacked cache system.

6. The stacked cache system of claim 1, wherein the stacked cache system is one of static random access memory (SRAM) in a vertical stacked orientation or dynamic random access memory (DRAM) in the vertical stacked orientation.

7. The stacked cache system of claim 1, further comprising a base die, and wherein the first cache die is integrated with the base die, and the second cache die is in the stacked orientation over the first cache die.

8. The stacked cache system of claim 7, wherein the cache control circuitry and a tag field are integrated with the base die, separate from the first cache die and the second cache die.

9. The stacked cache system of claim 7, wherein the cache control circuitry and a tag field are integrated with the base die, and the first cache die and the second cache die are stacked data arrays.

10. The stacked cache system of claim 9, wherein the cache control circuitry is configured to perform a tag lookup prior to a vertical access request into the stacked data arrays via the connection vias that are configured vertically in the center of the stacked cache system.

11. A method, comprising:
accessing data in a stacked cache system by connection vias configured vertically in a center of the stacked cache system that comprises a first cache die and a second cache die in a stacked orientation with the first cache die; and
controlling data inputs and data outputs with cache control circuitry centrally located in the stacked cache system.

12. The method of claim 11, wherein the cache control circuitry vertically bifurcates between the first cache die and the second cache die.

13. The method of claim 11, wherein the stacked cache system is a layer2 (L2) stacked cache with a vertical orientation of the second cache die located over the first cache die.

14. The method of claim 11, wherein the stacked cache system is one of static random access memory (SRAM) in a vertical stacked orientation or dynamic random access memory (DRAM) in the vertical stacked orientation.

15. The method of claim 11, wherein the first cache die is integrated with a base die of the stacked cache system, and the second cache die is in the stacked orientation over the first cache die.

16. The method of claim 11, wherein the cache control circuitry and a tag field are integrated with a base die of the stacked cache system, separate from the first cache die and the second cache die.

17. The method of claim 11, wherein the cache control circuitry and a tag field are integrated with a base die of the stacked cache system, and the first cache die and the second cache die are stacked data arrays.

18. The method of claim 17, further comprising performing a tag lookup prior to a vertical access request into the stacked data arrays via the connection vias that are configured vertically in the center of the stacked cache system.

19. A stacked cache system, comprising:
a first cache die integrated with a base die;
a second cache die in a stacked orientation with the first cache die; and
cache control circuitry centrally located in the stacked cache system, the cache control circuitry configured to control data inputs and data outputs via connection vias configured vertically in a center of the stacked cache system.

20. The stacked cache system of claim 19, wherein the cache control circuitry and a tag field are integrated with the base die, separate from the first cache die and the second cache die.
